(19) United States
(12) Patent Application Publication
(10) Pub. No.: US 2026/0120312 A1
(43) Pub. Date: Apr. 30, 2026

(54) METHOD FOR DETERMINING A HEIGHT OF A TRAILER WHEN HITCHING

(71) Applicant: ZF CV Systems Global GmbH, Bern (CH)

(72) Inventors: Krunal Patel, Ypsilanti, MI (US); Alec Vucsko, West Lafayette, IN (US); Akshay Bapat, Lafayette, IN (US)

(21) Appl. No.: 18/925,976

(22) Filed: Oct. 24, 2024

(51) Int. Cl. G06T 7/73

(52) U.S. Cl. CPC G06T 7/73; G06T 2207/30252

(57) ABSTRACT

A method is for determining a height of a trailer. The method includes capturing an image of the trailer via a camera on a tractor vehicle, wherein the camera faces rearward with respect to the tractor vehicle; identifying the trailer via the camera of the tractor vehicle; and, determining a height of the trailer, wherein the height is a distance between a bottom edge of the trailer and the ground on which the trailer is disposed. A system is for a tractor vehicle for determining a height of a trailer. The system includes a camera, a height determination module configured to identify the trailer from an output of the camera; and, the height determination module being further configured to determine the height of the trailer.

### BACKGROUND

In a reversing maneuver to attach a trailer to a truck, the driver of the truck needs to know the height of the trailer in order to be able to safely connect the fifth wheel of the truck to the kingpin of the trailer. In order to determine whether the trailer is at a sufficient height, the driver must exit the truck and visually check the height of the trailer before returning to the truck to perform the maneuver. The need to get out and visually inspect the trailer height requires additional time for connecting the trailer to the truck. This can especially effect efficiency in the context of a terminal tractor, also referred to as a yard truck, shag truck, shunt truck, et cetera. This is the case because terminal tractors operate in a cargo yard, warehouse facility, or intermodal facility and move trailers around the facility.

Accordingly, terminal tractors spend a higher percentage of their operating time hitching to different trailers.

### SUMMARY

It is an object of the disclosure to provide a method for determining a trailer height via a depth camera. This object is, for example achieved via a method for determining a height of a trailer. The method includes capturing an image of the trailer via a camera on a tractor vehicle, wherein the camera faces rearward with respect to the tractor vehicle; identifying the trailer via the camera of the tractor vehicle; and,
determining a height of the trailer, wherein the height is a distance between a bottom edge of the trailer and the ground on which the trailer is disposed.

According to various embodiments of the disclosure, the method further includes comparing the determined height of the trailer to a predetermined height threshold or height range for hitching the trailer to a truck.

According to various embodiments of the disclosure, the method further includes alerting a driver if the determined height of the trailer is below the predetermined height threshold or is outside the height range.

According to various embodiments of the disclosure, the method further includes braking the tractor vehicle if the tractor vehicle is backing up towards the trailer and the determined height of the trailer is below the predetermined height threshold or is outside of the height range.

According to various embodiments of the disclosure, the method further includes displaying a camera feed and at least one of a height threshold and a height range on a display for a driver.

According to various embodiments of the disclosure, the method further includes determining at least one of a trailer type and trailer size; and, comparing the determined height of the trailer to a predetermined height threshold for the determined at least one of the trailer type and the trailer size or height range for hitching the trailer to a truck for the determined at least one of the trailer type and the trailer size.

According to various embodiments of the disclosure, the trailer and the towing vehicle are disposed on a surface having a slope and the slope is taken into account when determining the height of the trailer.

According to alternative embodiments of the disclosure, the height of the trailer is determined via a method including capturing an image of a front end of the trailer via a camera, identify the trailer in the captured image, isolating a bottom edge of the trailer in the captured image, and, determining a height of the bottom edge with respect to the ground on which the trailer is disposed.

According to various embodiments of the disclosure, the height is determined at a plurality of locations of the bottom edge and the determined heights are averaged to provide an average determined height.

According to various embodiments of the disclosure, the bottom edge is isolated via at least one of point-cloud data and image edge detection.

According to various embodiments of the disclosure, the method further includes comparing the determined height of the bottom edge to a threshold value to determine whether the trailer is within an appropriate height range to be hitched to a fifth wheel of the towing vehicle.

According to various embodiments of the disclosure, the method further includes warning a driver if the determined height is outside of the appropriate height range, and, braking the towing vehicle if the determined height is outside of the appropriate height range.

According to various embodiments of the disclosure, the method further includes displaying a video feed from the camera to the driver, wherein a detected pixel range of the bottom edge and a reference pixel range indicating an appropriate height of the bottom edge for hitching the trailer to the towing vehicle are superimposed onto the video feed.

It is a further object of the disclosure to provide a trailer height measurement system. This object is, for example, achieved via a system for a tractor vehicle for determining a height of a trailer. The system includes a camera, a height determination module configured to identify the trailer from an output of said camera, and, the height determination module being further configured to determine the height of the trailer.

According to various embodiments, the height determination unit is further configured to compare the determined height of the trailer to a predetermined height threshold or height range.

According to various embodiments, the height determination module is further configured to alert a driver if the determined height is below the predetermined height threshold or is outside of the height range.

According to various embodiments, the height determination module is further configured to brake the tractor if the tractor is backing up towards the trailer and the determined height of the trailer is below the predetermined threshold or is outside of the height range.

According to various embodiments, a feed from the camera is displayed on a dashboard of the tractor vehicle.

According to various embodiments, at least one of a predetermined height threshold or a height range is displayed on the dashboard along with the feed from the camera.

According to various embodiments, the height determination module is configured to determine the height of the trailer when the truck vehicle is within 3 meters of the trailer.

According to various embodiments, the height determination module is configured to determine the height of the trailer on a flat surface.

According to various embodiments, the height determination module is configured to determine at least one of a trailer type and a trailer size and to compare the determined height of the trailer to a height threshold or height range specific to the determined at least one of trailer type and trailer size.

According to various embodiments, a height determination module includes a non-transitory computer readable medium having program code stored thereon. The program code being configured, when executed by a processor, to perform a method disclosed herein.

According to various embodiments, a tractor vehicle includes a system disclosed herein. The tractor vehicle can, for example, be a terminal tractor.

### BRIEF DESCRIPTION OF DRAWINGS

The invention will now be described with reference to the drawings wherein:

FIG. 1 shows a system for determining the height of a trailer;

FIG. 2A shows a trailer to be hitched to a towing vehicle, wherein the trailer is at an appropriate height for hitching;

FIG. 2B shows a trailer to be hitched to a towing vehicle, wherein the trailer is not at an appropriate height for hitching;

FIG. 3 shows a trailer to be hitched to a towing vehicle, wherein the towing vehicle and the trailer are at an angle to each other;

FIG. 4 is a flowchart showing an embodiment of a method according to the disclosure;

FIG. 5 is a flowchart showing a further embodiment of a method according to the disclosure; and,

FIG. 6 shows the flowchart of FIG. 5 with an additional step.

### DETAILED DESCRIPTION

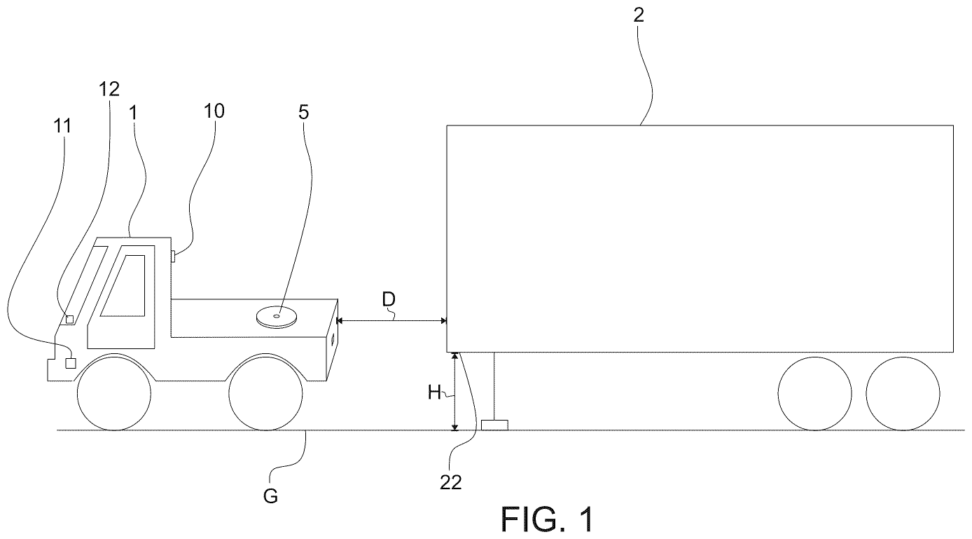

FIG. 1 shows a towing vehicle 1, here a terminal tractor, positioned at a distance D away from a trailer 2. Before reversing to connect the trailer 2 to the towing vehicle 1 via the fifth wheel 5, it must be determined whether the trailer is at an appropriate height H. If the towing vehicle 1 reverses when the trailer 2 is too low, damage to the trailer 2 and the towing vehicle 1 can result.

The towing vehicle 1 includes a sensor 10. The sensor 10 can, for example, be a camera. The sensor 10 is directed rearward so as to be able to capture the trailer 2 positioned behind the towing vehicle 1. The sensor 10 transmits data captured by the sensor, for example a digital image, to a processing unit 11. The processing unit 11 identifies the trailer 2 in the digital image recorded by the sensor 10. After identifying the trailer 2 in the image captured by the sensor 10, the processing unit 11 determines the height H of the trailer 2. The height H of the trailer can, for example, be determined as a distance between the bottom edge 22 of the trailer 2 and the ground G on which the trailer 2 is positioned.

In order to determine whether the trailer 2 is at the correct height H, the processing unit 11 can compare the determined height H to a predetermined permissible height or height range. In the event the trailer 2 is not at an appropriate height for backing up the towing vehicle 1 for hitching the trailer 2 thereto, the processing unit can alert an operator. The operator can be alerted via, for example, an auditory signal or a warning via a display device 12, such as a warning light, an icon on a screen, or the like. The display device 12 can also display a camera feed from the sensor 10. Further, the processing unit 11 can overlay a graphic or other indication of whether the trailer 2 is at an appropriate height H.

According to various embodiments, the towing vehicle 1 is automatically braked if hitching is determined to not be possible because the trailer 2 is not at an appropriate height H.

According to various embodiments, the trailer 2 is to be at a predetermined distance or within a predetermined distance range from the towing vehicle 1, for example, three meters.

According to various embodiments, the trailer 2 and the towing vehicle 1 are to be on a flat surface when being hitched to one another.

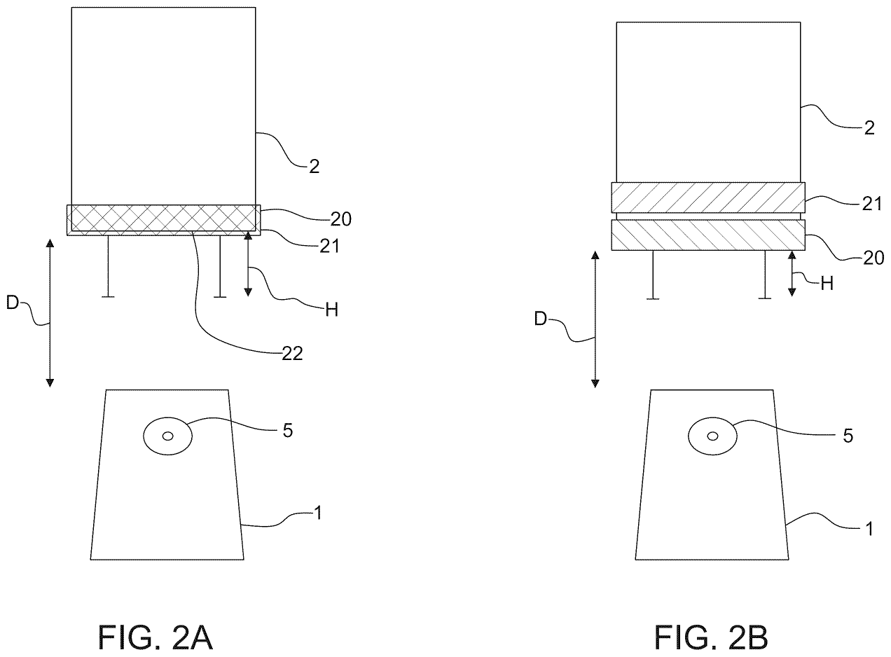

FIG. 2A shows a towing vehicle 1 positioned in front of a trailer 2 at a distance D. The trailer 2 is at a height H. In FIG. 2A, the processing unit 11 has identified the trailer 2 and located the bottom edge 22 of the trailer 2. In FIG. 2A, the bottom edge 22 of the trailer 2 has been marked in the image by a box representing a detected edge pixel range 20. The box marked by reference numeral 21 represents a reference pixel range 21 that is where the bottom edge 22 of the trailer 2 should be if it is safe for hitching. If the bottom edge 22 of the trailer 2 is at a predetermined height H at which the trailer 2 can be hitched to the towing vehicle 1, the reference pixel range 21 and the detected edge pixel range 20 overlap or coincide as shown in FIG. 2A. The processing unit 11 then determine that the trailer 2 can be hitched to the towing vehicle, for example if the detected edge pixel range 20 and the reference pixel range 21 overlap to a predetermined amount.

As in FIG. 2A, FIG. 2B shows a towing vehicle 1 positioned in front of a trailer 2 at a distance D. The trailer 2 is at a height H. The bottom edge 22 of the trailer has been detected in the detected edge pixel range 20. In FIG. 2B, however, the trailer 2 is at a lower height H than in FIG. 2A and the reference pixel range 21 does not overlap with the detected edge pixel range 20. If the towing vehicle 1 were to reverse for hitching the trailer 2 to the fifth wheel 5 in such a situation, damage could, for example, result to the towing vehicle 1 or the trailer 2. Accordingly, the trailer 2 is unsafe for hitching. If the trailer 2 is unsafe for hitching, the driver or someone else will have to adjust the height of the trailer before the hitching process can be performed.

According to various embodiments, a video feed from the sensor 10 is provided to a driver via a display device 12. The detected edge pixel range 20 and the reference pixel range 21 can be superimposed onto the video feed showing the driver the relative locations of the detected edge pixel range 20 and the reference pixel range 21.

According to various embodiments of a method according to the disclosure, it is initially determined whether the towing vehicle 1 is at an appropriate distance D from the trailer 2 for determining the height H of the trailer. This can be determined via a sensor 10, for example a camera or a distance sensor such as a 2D LiDAR sensor, a depth camera, and a radar sensor. If the towing vehicle 1 is at an appropriate distance D from the trailer 2, it is determined whether the trailer 2 is at an appropriate height H for being hitched to the towing vehicle 1. The height H of the trailer 2 can be determined via a distance of a bottom edge 22 of the trailer to the ground G on which the trailer 2 is disposed. A display device 12 can be used to inform the driver of whether the trailer 2 is at an appropriate height H for hitching. If the towing vehicle 1 reverses towards the trailer 2 despite the trailer 2 not being at an appropriate height H, an indicator, for example visual or auditory, can be provided to the driver and/or the towing vehicle 1 can be automatically braked to avoid a collision.

In an alternative embodiment of a method, the towing vehicle 1 can be at varying distances to the trailer 2 and it is still possible to determine whether the height H of the trailer 2 is appropriate for hitching the trailer 2 to the fifth wheel 5 of the towing vehicle 1. Initially, an image is captured via a sensor 10. The sensor 10 is directed rearward with respect to the towing vehicle 1 and captures the environment behind the towing vehicle 1. The trailer 2 is located within the image.

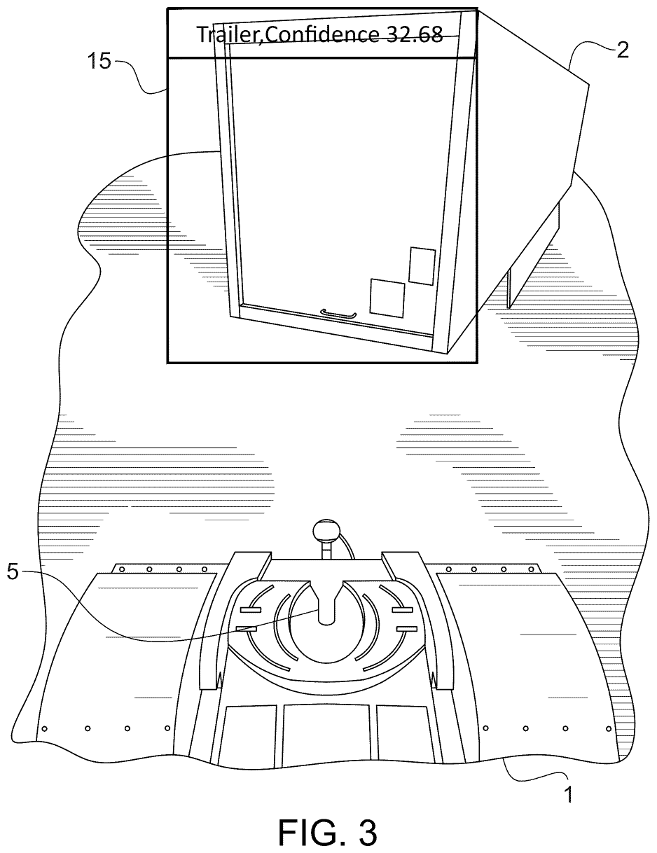

FIG. 3 shows an example schematic of an image captured by the sensor 10. A search region 15, in which the trailer 2 is to be superimposed on the image, can be expanded to include the entire image vertically. The bottom edge 22 of the trailer 2 is then isolated. The bottom edge 22 can, for example, be isolated via point-cloud to differentiate the bottom edge 22 from the rest of the image and/or image edge-detection can be used therefor. If different heights H are determined at different locations of the bottom edge 22, the different heights can be averaged. Different measurement heights can, for example, result from sensor noise or objects that are not part of the trailer accidently being included in the measurement. For such embodiments, the towing vehicle 1 and the trailer 2 need not be at a specific distance to one another. Further, this method can be performed on a non-flat surface and/or on a sloping surface. If the configuration of the ground is known or the slope of the ground is known, the ground configuration and/or slope can be taken into account when determining the height of the trailer. If the ground configuration or slope is unknown, a point cloud can, for example, be used to evaluate the ground under the trailer and the results can be taken into account when determining the height of the trailer.

According to various embodiments, a trailer type and/or trailer size can be determined from an image captured by the sensor 10. On a basis of the type of trailer determined, the determined height can be compared to a predetermined height threshold or range for the determined trailer type and/or trailer size.

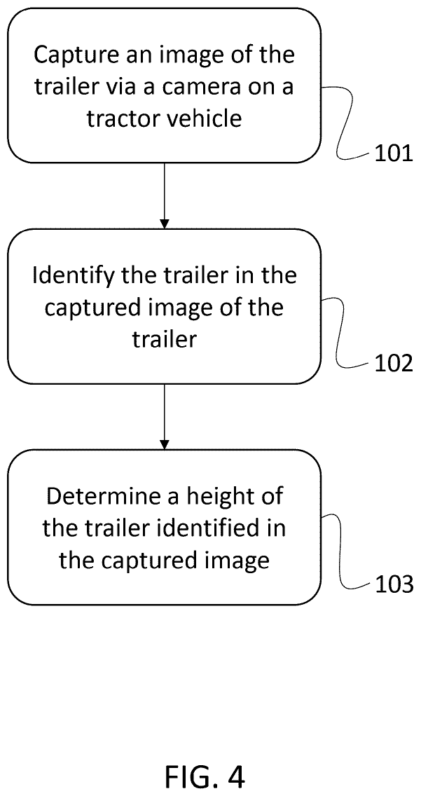

FIG. 4 shows an embodiment of a method according to the disclosure. In a first step 101, an image of the trailer is captured via camera disposed on the tractor. The camera can be positioned on the tractor so as to face rearward. In a second step 102, the trailer is identified in the image captured by the camera. In step 103, a height of the trailer is determined. The height of the trailer is a distance between a bottom edge of the trailer and the ground on which the trailer is disposed.

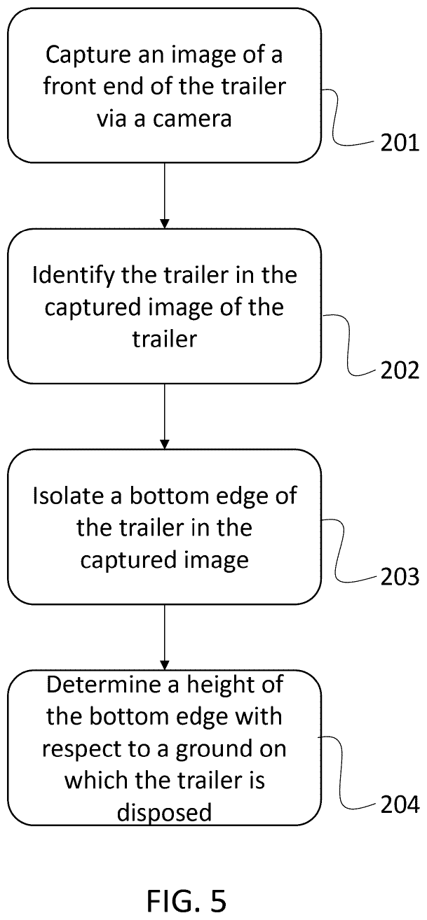

FIG. 5 shows a further embodiment of a method according to the disclosure. In a first step 201, an image of the front end of the trailer is captured via the image sensor 10, for example, a camera. The camera can be positioned on the tractor in rearward facing manner. In a second step 202, the trailer is identified in the image captured by the camera. In step 203, the bottom edge of the trailer is isolated in the captured image. In a step 204, the height of the trailer is determined with respect to the ground on which the trailer is disposed. According to an embodiment of the disclosure, the point cloud provides relative x-y-z coordinates, in particular z coordinates, for each point on the bottom edge isolated in step 203. An average of the z coordinates of the bottom edge can be determined in order to compensate for any errors in the point cloud.

According to various embodiments, if the image sensor 10 is aligned with the fifth wheel 5 of the towing vehicle 1, the angle of the trailer can be determined from the image. If the image sensor 10 is not aligned with the fifth wheel 5 but rather is disposed at an angle thereto, the angle between the image sensor 10 and a longitudinal axis of the towing vehicle through the fifth wheel 5 needs to be known or determined in order to ensure proper alignment of the towing vehicle to the trailer 2.

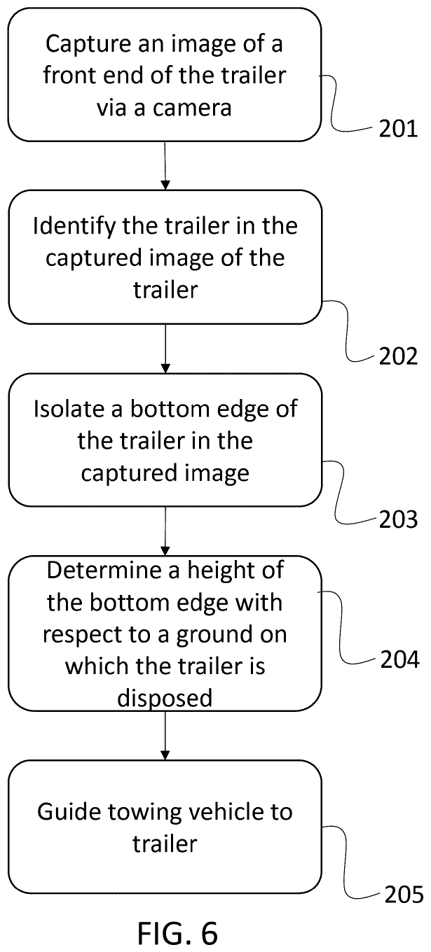

According to various embodiments, as shown in FIG. 6, the towing vehicle is guided to the trailer in step 206. The towing vehicle 1 can be guided to trailer 2 autonomously, that is without intervention by the driver. When the trailer 2 is disposed at an angle to the towing vehicle 1, the system can control the steering wheel or otherwise manipulate the steering and the drive of the towing vehicle 1 to move the towing vehicle 1 to the trailer 2. Alternatively, the system can control the steering while an operator controls the drive according to instructions provided by the system. Further, the system can give the operator guiding instructions, for example via a human machine interface.

The system can alert the operator to various situations such as when the operator needs to realign the towing vehicle 1 to the trailer 2 prior to hitching. The alert can be an auditory alert, for example, warning the driver of the need to realign before attempting to hitch the trailer 2 to the towing vehicle. A warning or indicator that the trailer is too high or too low can also be provided via a screen of a human machine interface. Alternatively, the system can nudge the steering wheel to alert the operator or apply the brakes of the towing vehicle to prevent an approach for hitching when the trailer is not at a correct height for hitching.

It is understood that the foregoing description is that of the preferred embodiments of the invention and that various changes and modifications may be made thereto without departing from the spirit and scope of the invention as defined in the appended claims.

### REFERENCE CHARACTERS

1 Towing Vehicle
2 Trailer
5 Fifth Wheel
10 Sensor
11 Processing Unit
12 Display Device
15 Search Region
20 Detected Edge Pixel Range
21 Reference Pixel Range
22 Bottom Edge
D Distance
G Ground
H Height
101-103 Method Steps
201-204 Method Steps

1. A method for determining a height of a trailer, the method comprising:
capturing an image of the trailer via a camera on a tractor vehicle, wherein the camera faces rearward with respect to the tractor vehicle;
identifying the trailer in the captured image of the trailer; and,
determining a height of the trailer identified in the captured image, wherein the height is a distance between a bottom edge of the trailer and a ground on which the trailer is disposed.

2. The method of claim 1 further comprising comparing the determined height of the trailer to a predetermined height threshold or height range for hitching the trailer to a truck.

3. The method of claim 2, further comprising alerting a driver if the determined height of the trailer is below the predetermined height threshold or is outside the height range.

4. The method of claim 2 further comprising braking the tractor vehicle if the tractor vehicle is backing up towards the trailer and the determined height of the trailer is below the predetermined height threshold or is outside of the height range.

5. The method of claim 1 further comprising displaying a camera feed and at least one of a height threshold and a height range on a display for a driver.

6. The method of claim 1 further comprising:
determining at least one of a trailer type and trailer size; and,
comparing the determined height of the trailer to a predetermined height threshold for the determined at least one of the trailer type and the trailer size or height range for hitching the trailer to a truck for the determined at least one of the trailer type and the trailer size.

7. The method of claim 1, wherein the trailer and the towing vehicle are disposed on a surface having a slope and the slope is taken into account when determining the height of the trailer.

8. A method for determining a height of a trailer, the method comprising:
capturing an image of a front end of the trailer via a camera;
identifying the trailer in the captured image;
isolating a bottom edge of the trailer in the captured image; and,
determining a height of the bottom edge with respect to a ground on which the trailer is disposed.

9. The method of claim 8, wherein the height is determined at a plurality of locations of the bottom edge and the determined heights are averaged to provide an average determined height.

10. The method of claim 8, wherein the bottom edge is isolated via at least one of point-cloud data and image edge detection.

11. The method of claim 8 further comprising comparing the determined height of the bottom edge to a threshold value to determine whether the trailer is within an appropriate height range to be hitched to a fifth wheel of a towing vehicle.

12. The method of claim 11 further comprising at least one of:
warning a driver if the determined height is outside of the appropriate height range; and,
braking the towing vehicle if the determined height is outside of the appropriate height range.

13. The method of claim 8 further comprising displaying a video feed from the camera to the driver, wherein a detected pixel range of the bottom edge of the trailer and a reference pixel range indicating an appropriate height of the bottom edge of the trailer for hitching the trailer to the towing vehicle are superimposed onto the video feed.

14. A system for a tractor vehicle for determining a height of a trailer, the system comprising:
a camera;
a height determination module configured to identify the trailer from an output of said camera; and,
said height determination module being further configured to determine the height of the trailer.

15. The system of claim 14, wherein said height determination unit is further configured to compare the determined height of the trailer to a predetermined height threshold or height range.

16. The system of claim 15, wherein said height determination module is further configured to alert a driver if the determined height is below said predetermined height threshold or is outside of said height range.

17. The system of claim 15, wherein said height determination module is further configured to brake the tractor if the tractor is backing up towards the trailer and the determined height of the trailer is below said predetermined threshold or is outside of said height range.

18. The system of claim 14, wherein a feed from said camera is displayed on a dashboard of the tractor vehicle.

19. The system of claim 18, wherein at least one of a predetermined height threshold or a height range is displayed on the dashboard along with said feed from said camera.

20. The system of claim 14, wherein said height determination module is configured to determine the height of the trailer when the truck vehicle is within 3 meters of the trailer.

21. The system of claim 14, wherein said height determination module is configured to determine the height of the trailer on a flat surface.

22. The system of claim 15, wherein said height determination module is configured to determine at least one of a trailer type and a trailer size and to compare the determined height of the trailer to a height threshold or height range specific to the determined at least one of trailer type and trailer size.

23. A height determination module comprising:
a non-transitory computer readable medium having program code stored thereon; and,
said program code being configured, when executed by a processor, to perform the method of claim 1.

24. A tractor vehicle comprising the system of claim 14.

25. The tractor vehicle of claim 24, wherein the tractor vehicle is a terminal tractor.
